(19) United States
(12) Patent Application Publication
(10) Pub. No.: US 2019/0384095 A1
(43) Pub. Date: Dec. 19, 2019

(54) LIQUID CRYSTAL DISPLAY PANEL AND LIQUID CRYSTAL DISPLAY DEVICE USING THE SAME

(71) Applicants: HKC Corporation Limited, Shenzhen City, Guangdong (CN); Chongqing HKC Optoelectronics Technology Corporation Limited, Chongqing (CN)

(72) Inventor: Yu-Jen CHEN, Chongqing (CN)

(21) Appl. No.: 15/550,429

(22) PCT Filed: Apr. 13, 2017
(86) PCT No.: PCT/CN2017/080441

§ 371 Date: Aug. 11, 2017

(30) Foreign Application Priority Data
Dec. 29, 2016 (CN) 201611249563.X

(51) Int. Cl. G02F 1/1335

(52) U.S. Cl. CPC G02F 1/133512; G02F 2001/133388; G02F 1/133528; G02F 1/133514

(57) ABSTRACT

This application relates to a liquid crystal display (LCD) panel and an LCD device using the same. The LCD panel includes: a first substrate, including an outer surface; a first polarizer, disposed on the outer surface of the first substrate; a second substrate, disposed opposite to the first substrate and provided with an outer surface; a second polarizer, disposed on the outer surface of the second substrate, where the second polarizer includes an outer surface; a liquid crystal (LC) layer, disposed between the first substrate and the second substrate; and a light shielding unit, disposed on a periphery of the outer surface of the second substrate or disposed on a periphery of the outer surface of the second polarizer.

### BACKGROUND

### Technical Field

This application relates to a bezel-less design method, and in particular, to a liquid crystal display (LCD) panel of a bezel-less design and an LCD device using the same.

### Related Art

A TFT-LCD is short for a thin film transistor LCD. The TFT-LCD is a backlight type LCD and includes an LCD panel and a backlight module. The LCD panel includes: a first substrate: a color filter (CF) substrate, a second substrate: a TFT substrate, and a liquid crystal (LC) sandwiched between the CF substrate and the TFT substrate. Low temperature poly-silicon (LTPS) is a process of manufacturing a new-generation TFT-LCD. A greatest difference between the LTPS and a conventional amorphous silicon (a-Si) display is that the LTPS has a relatively high reaction speed, and has advantages such as high luminance, high resolution, and low power consumption. The TFT-LCD has two technologies, that is, a poly-silicon technology and an a-Si technology. Currently, popular TFT-LCDs are mainly based on a-Si, and related technologies are relatively mature. Because the LCD cannot emit light, the backlight module is required. The backlight module may include a light source such as a light-emitting diode or a fluorescent lamp, a light guide plate, a prism sheet, a diffuser, a protective sheet and the like.

To highlight integrity of a displayed picture, a TFT-LCD starts to use a bezel-less design. However, after a bezel is cancelled, a problem of side light leakage of an edge needs to be overcome; otherwise, a peripheral light leakage phenomenon occurs. Moreover, when a panel array side of a bezel-less product is displayed upwards, surrounding metal reflection leads to poor visual sense, affecting quality of a panel.

### SUMMARY

To resolve the foregoing technical problem, an objective of this application is to provide a bezel-less design method, and in particular, this application relates to an LCD panel of a bezel-less design, so as to not only absorb metal light reflection surrounding a TFT glass substrate, but also alleviate a problem of poor visual sense due to metal light reflection.

The objective of this application is achieved and the technical problem of this application is resolved by using the following technical solution. According to this application, an LCD panel is provided, including: a first substrate, including an outer surface; a first polarizer, disposed on the outer surface of the first substrate; a second substrate, disposed opposite to the first substrate and including an outer surface; a second polarizer, disposed on the outer surface of the second substrate, where the second polarizer includes an outer surface; an LC layer, disposed between the first substrate and the second substrate; and a light shielding unit, disposed on a periphery of the outer surface of the second substrate or disposed on a periphery of the outer surface of the second polarizer.

The objective of this application may also be further achieved and the technical problem of this application may also be further resolved by using the following technical measure.

An LCD device includes a backlight module and further includes the LCD panel.

In an embodiment of this application, when the light shielding unit is disposed on the periphery of the outer surface of the second substrate, the light shielding unit is located between the second substrate and the second polarizer.

In an embodiment of this application, the LCD device includes a covering layer, where the covering layer is disposed on the outer surface of the second polarizer; and when the light shielding unit is disposed on the periphery of the outer surface of the second polarizer, the light shielding unit is located between the second polarizer and the covering layer.

In an embodiment of this application, the light shielding unit is made of a black material.

In an embodiment of this application, the black material is a black photoresist.

In an embodiment of this application, the light shielding unit may be equal in width or unequal in width, or portions of the light shielding unit are equal in width.

By means of this application, not only metal light reflection surrounding a TFT glass substrate can be absorbed, but also a problem of poor visual sense due to metal light reflection can be alleviated.

### BRIEF DESCRIPTION OF THE DRAWINGS

FIG. 1 is a schematic structural diagram of a backlight module of an exemplary conventional LCD;

FIG. 1a is a schematic diagram of an exemplary panel array layer;

FIG. 1b is a schematic diagram of a panel array layer that includes a black material and that is below a covering layer according to an embodiment of this application;

FIG. 2a is a schematic diagram of an exemplary panel array layer; and

FIG. 2b is a schematic diagram of a panel array layer that includes a black material and that is on a surface of a TFT glass substrate according to an embodiment of this application.

### DETAILED DESCRIPTION

The following embodiments are described with reference to the accompany drawings, and are used to exemplarily show particular embodiments in this application that may be implemented. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the descriptions are considered to be essentially exemplary, rather than limitative. In the figures, units with similar structures are represented by same numerals. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe the technical means used in this application to achieve the present invention objective and effects thereof, specific implementations, structures, features, and effects of an LCD panel and an LCD device using the same provided according to this application are described in detail below with reference to the accompanying drawings and preferred embodiments.

An LCD applies an electric field to an LC between two glass substrates, so as to display numbers or images. The LC is formed by a substance intermediate between liquid and solid. Because the LCD cannot emit light, a backlight module is required to provide light. A picture is formed by controlling light transmission of the LCD panel. The LC is evenly disposed in the LCD panel.

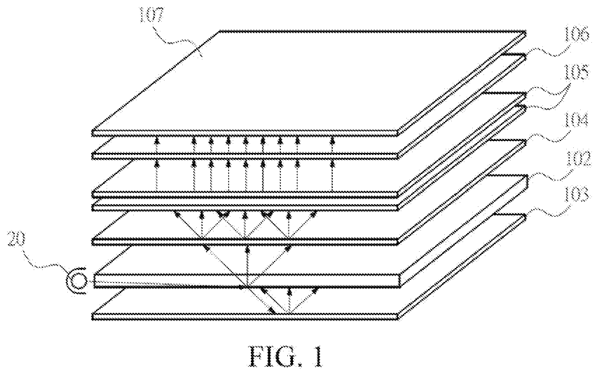

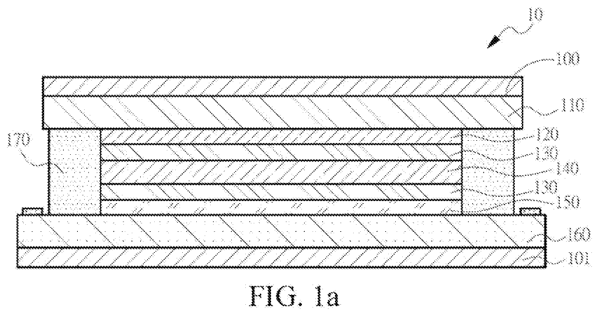

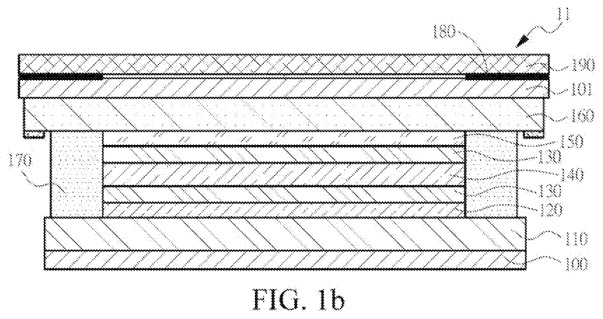

A backlight module (as shown in FIG. 1) of a conventional LCD includes a light source 20, a light guide plate 102, a reflection sheet 103, a diffuser 104, a prism sheet 105, and a protective sheet 106. First, the light source 20 is configured to emit light to the LCD. Currently, there are multiple different light sources that can be applied to the LCD. The light guide plate 102 is disposed below an LCD panel 107 and adjacent to one side of the light source 20. The light guide plate 102 is configured to convert dot-shaped light generated by the light source 20 into planar light, and project the planar light to the LCD panel 107.

The reflection sheet 103 is disposed below the light guide plate 102. The reflection sheet 103 is configured to reflect the light emitted by the light source 20 to the LCD panel 107 in front of the reflection sheet 103. The diffuser 104 is disposed above the light guide plate 102 and is configured to homogenize the light passing through the light guide plate 102. When the light passes through the diffuser 104, the light is diffused in horizontal and vertical directions. Therefore, luminance of the light rapidly reduces. For this point, the prism sheet 105 is configured to refract and concentrate light, so as to improve luminance. Generally, two prism sheets 105 are arranged in a manner of being perpendicular to each other.

The protective sheet 106 is disposed above the prism sheet 105. When two prism sheets 105 that are arranged in a manner of being perpendicular to each other are used, the protective sheet 106 can avoid scratches of the prism sheets 105 and avoid a moire effect. The backlight module of the conventional LCD includes the foregoing components.

Generally, when the prism sheet 105 is normally assembled, several unit prisms are arranged on a transparent material film in a regular direction. The prism sheet 105 is configured to refract the light that passes through the light guide plate 102 and that is diffused by the diffuser 104. Generally, if widths of transmitted light and refracted light are relatively small, light in transmission and refraction areas is relatively bright. On the contrary, if widths of transmitted light and refracted light are relatively large, light in transmission and refraction areas is relatively dim.

In recent years, an LCD tends to have a panel of a large size. Therefore, how to maintain density of light emitted by the backlight module above a predetermined level is a problem. Moreover, to highlight integrity of a displayed picture, the LCD starts to use a bezel-less design. However, after the bezel is cancelled, a problem of side light leakage of an edge needs to be overcome; otherwise, a peripheral light leakage phenomenon occurs. Moreover, when a panel array side of a bezel-less product is displayed upwards, surrounding metal reflection leads to poor visual sense, affecting quality of a panel. Therefore, how to homogenize the light that is seen and resolve the side light leakage problem of the edge is an important reference factor for a panel of a large size.

An LCD device of this application may include a backlight module and an LCD panel. The LCD panel may include a TFT substrate, a CF substrate, and an LC layer formed between two substrates.

In an embodiment, the LCD panel of this application may be a curved display panel, and the LCD device of this application may also be a curved display device.

FIG. 1a is a schematic diagram of an exemplary panel array layer 10; and FIG. 1b is a schematic diagram of a panel array layer 11 that includes a black material and that is below a covering layer according to an embodiment of this application. Referring to FIG. 1a and FIG. 1b, in an embodiment of this application, the LCD panel 11 includes: a first substrate 110, including an outer surface; a first polarizer 100, disposed on the outer surface of the first substrate 110; a second substrate 160, disposed opposite to the first substrate 110 and including an outer surface; a second polarizer 101, disposed on the outer surface of the second substrate 160, where the second polarizer 101 includes an outer surface; an LC layer 140, disposed between the first substrate 110 and the second substrate 160; and a sealant 170, disposed on a periphery between the first substrate 110 and the second substrate 160 and surrounding the LC layer 140; and further includes: a light shielding unit 180, disposed on a periphery of the outer surface of the second polarizer 101. Moreover, when the light shielding unit 180 is disposed on the periphery of the outer surface of the second polarizer 101, the light shielding unit 180 is located between the second polarizer 101 and the covering layer 190.

In an embodiment, a CF layer pattern 120 is located between the first substrate 110 and an optical spacer layer 130.

In an embodiment, a TFT array substrate 150 is located between the second substrate 160 and the optical spacer layer 130.

In an embodiment, a method for forming the light shielding unit 180 and the covering layer 190 includes exposing and developing processes or a printing process.

In an embodiment, a method for forming the first substrate 110 and the second substrate 160 includes photoresist coating, exposing, developing, and photomask processes.

In an embodiment, the light shielding unit 180 is made of a black material, and the light shielding unit 180 may be made of black insulation ink and arranged in a bezel area, so that a protective cover plate presents a black bezel. During a bezel-less design, a sense of design of a bezel is created, so as to achieve an objective of beautifying an appearance.

In an embodiment, the black material 180 is a black photoresist.

In an embodiment, the light shielding unit may be equal in width or unequal in width, or portions of the light shielding unit are equal in width.

In an embodiment, the first substrate 110 is a CF substrate.

In an embodiment, the second substrate 160 is a TFT substrate.

In an embodiment, the LCD panel 11 includes an LC layer 140, disposed between the first substrate 110 and the second substrate 160.

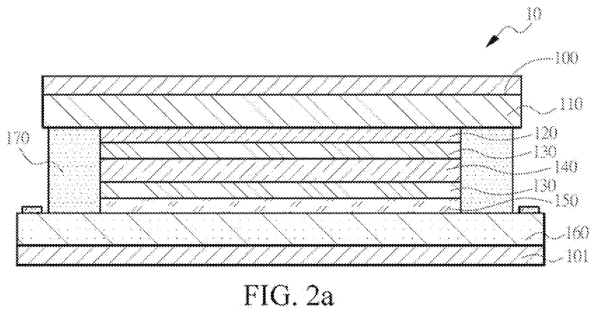

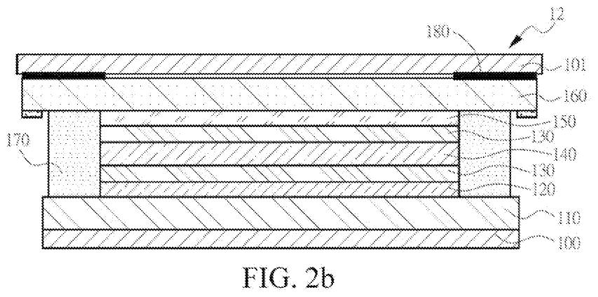

FIG. 2a is a schematic diagram of an exemplary panel array layer 10; and FIG. 2b is a schematic diagram of a panel array layer 12 that includes a black material and that is on a surface of a TFT glass substrate according to an embodiment of this application. Referring to FIG. 2a and FIG. 2b, in an embodiment of this application, the LCD panel 12 includes: a first substrate 110, including an outer surface; a first polarizer 100, disposed on the outer surface of the first substrate 110; a second substrate 160, disposed opposite to the first substrate 110 and including an outer surface; a second polarizer 101, disposed on the outer surface of the second substrate 160, where the second polarizer 101 includes an outer surface; an LC layer 140, disposed between the first substrate 110 and the second substrate 160; and a sealant 170,disposed on a periphery between the first substrate 110 and the second substrate 160 and surrounding the LC layer 140; and further includes: a light shielding unit 180, disposed on a periphery of the outer surface of the second substrate 160. Moreover, when the light shielding unit 180 is disposed on the periphery of the outer surface of the second substrate 160, the light shielding unit 180 is located between the second substrate 160 and the second polarizer 101.

In an embodiment, a CF layer pattern 120 is located between the first substrate 110 and an optical spacer layer 130.

In an embodiment, a TFT array substrate 150 is located between the second substrate 160 and the optical spacer layer 130.

In an embodiment, a method for forming the light shielding unit 180 and the covering layer 190 includes exposing and developing processes or a printing process.

In an embodiment, a method for forming the first substrate 110 and the second substrate 160 includes photoresist coating, exposing, developing, and photomask processes.

In an embodiment, the light shielding unit 180 is made of a black material, and the light shielding unit 180 may be made of black insulation ink and arranged in a bezel area, so that a protective cover plate presents a black bezel. During a bezel-less design, a sense of design of a bezel is created, so as to achieve an objective of beautifying an appearance.

In an embodiment, the black material 180 is a black photoresist.

In an embodiment, the light shielding unit may be equal in width or unequal in width, or portions of the light shielding unit are equal in width.

In an embodiment, the first substrate 110 is a CF substrate.

In an embodiment, the second substrate 160 is a TFT substrate.

In an embodiment, the LCD panel 12 includes an LC layer 140, is disposed between the first substrate 110 and the second substrate 160.

Referring to FIG. 1a and FIG. 1b, in an embodiment of this application, an LCD device includes a backlight module and an LCD panel 11, where the LCD panel 11 includes: a first substrate 110, including an outer surface; a first polarizer 100, disposed on the outer surface of the first substrate 110; a second substrate 160, disposed opposite to the first substrate 110 and including an outer surface; a second polarizer 101, disposed on the outer surface of the second substrate 160, where the second polarizer 101 includes an outer surface; and an LC layer 140, disposed between the first substrate 110 and the second substrate 160; and further includes: a light shielding unit 180, disposed on a periphery of the outer surface of the second polarizer 101. Moreover, when the light shielding unit 180 is disposed on the periphery of the outer surface of the second polarizer 101, the light shielding unit 180 is located between the second polarizer 101 and the covering layer 190.

In an embodiment, a CF layer pattern 120 is located between the first substrate 110 and an optical spacer layer 130.

In an embodiment, a TFT array substrate 150 is located between the second substrate 160 and the optical spacer layer 130.

In an embodiment, a method for forming the light shielding unit 180 and the covering layer 190 includes exposing and developing processes or a printing process.

In an embodiment, a method for forming the first substrate 110 and the second substrate 160 includes photoresist coating, exposing, developing, and photomask processes.

In an embodiment, the light shielding unit 180 is made of a black material, and the light shielding unit 180 may be made of black insulation ink and arranged in a bezel area, so that a protective cover plate presents a black bezel. During a bezel-less design, a sense of design of a bezel is created, so as to achieve an objective of beautifying an appearance.

In an embodiment, the black material 180 is a black photoresist.

In an embodiment, the light shielding unit may be equal in width or unequal in width, or portions of the light shielding unit are equal in width.

In an embodiment, the first substrate 110 is a CF substrate.

In an embodiment, the second substrate 160 is a TFT substrate.

In an embodiment, the LCD device includes an LC layer 140, disposed between the first substrate 110 and the second substrate 160.

Referring to FIG. 2a and FIG. 2b, in an embodiment of this application, an LCD device includes a backlight module and an LCD panel 12, where the LCD panel 12 includes: a first substrate 110, including an outer surface; a first polarizer 100, disposed on the outer surface of the first substrate 110; a second substrate 160, disposed opposite to the first substrate 110 and including an outer surface; a second polarizer 101, disposed on the outer surface of the second substrate 160, where the second polarizer 101 includes an outer surface; an LC layer 140, disposed between the first substrate 110 and the second substrate 160; and a sealant 170, disposed on a periphery between the first substrate 110 and the second substrate 160 and surrounding the LC layer 140; and further includes: a light shielding unit 180, disposed on a periphery of the outer surface of the second substrate 160. Moreover, when the light shielding unit 180 is disposed on the periphery of the outer surface of the second substrate 160, the light shielding unit 180 is located between the second substrate 160 and the second polarizer 101.

In an embodiment, a CF layer pattern 120 is located between the first substrate 110 and an optical spacer layer 130.

In an embodiment, a TFT array substrate 150 is located between the second substrate 160 and the optical spacer layer 130.

In an embodiment, a method for forming the light shielding unit 180 includes exposing and developing processes or a printing process.

In an embodiment, a method for forming the first substrate 110 and the second substrate 160 includes photoresist coating, exposing, developing, and photomask processes.

In an embodiment, the light shielding unit 180 is made of a black material, and the light shielding unit 180 may be made of black insulation ink and arranged in a bezel area, so that a protective cover plate presents a black bezel. During a bezel-less design, a sense of design of a bezel is created, so as to achieve an objective of beautifying an appearance.

In an embodiment, the black material 180 is a black photoresist.

In an embodiment, the light shielding unit may be equal in width or unequal in width, or portions of the light shielding unit are equal in width.

In an embodiment, the first substrate 110 is a CF substrate.

In an embodiment, the second substrate 160 is a TFT substrate.

In an embodiment, the LCD device includes an LC layer 140, disposed between the first substrate 110 and the second substrate 160.

In some embodiments, a CF and a TFT may be formed on a same substrate.

By means of this application, not only metal light reflection surrounding a TFT glass substrate can be absorbed, but also a problem of poor visual sense due to metal light reflection can be alleviated.

Phases such as “in some embodiments” and “in various embodiments” are repeatedly used. The phases generally do not refer to same embodiments, but the phases may refer to same embodiments. Words such as “contain”, “have”, and “include” are synonyms, unless other meanings are indicated in the context.

The above descriptions are merely preferred embodiments of this application, and are not intended to limit this application in any form. Although this application has been disclosed above through the preferred embodiments, the embodiments are not intended to limit this application. A person skilled in the art can make some equivalent variations, alterations or modifications to the above-disclosed technical content without departing from the scope of the technical solutions of this application to obtain equivalent embodiments. Any simple alteration, equivalent change or modification made to the above embodiments according to the technical essence of this application without departing from the content of the technical solutions of this application shall fall within the scope of the technical solutions of this application.

What is claimed is:

1. A liquid crystal display (LCD) panel, comprising:
a first substrate, including an outer surface;
a first polarizer, disposed on the outer surface of the first substrate;
a second substrate, disposed opposite to the first substrate and including an outer surface;
a second polarizer, disposed on the outer surface of the second substrate, wherein the second polarizer includes an outer surface;
a liquid crystal (LC) layer, disposed between the first substrate and the second substrate; and
a light shielding unit disposed on a periphery of the outer surface of the second substrate or disposed on a periphery of the outer surface of the second polarizer.

2. The LCD panel according to claim 1, wherein, when the light shielding unit is disposed on the periphery of the outer surface of the second substrate, the light shielding unit is located between the second substrate and the second polarizer.

3. The LCD panel according to claim 2, wherein the light shielding unit is made of a black material.

4. The LCD panel according to claim 3, wherein the black material is a black photoresist.

5. The LCD panel according to claim 1, further comprising a covering layer, wherein the covering layer is disposed on the outer surface of the second polarizer; and when the light shielding unit is disposed on the periphery of the outer surface of the second polarizer, the light shielding unit is located between the second polarizer and the covering layer.

6. The LCD panel according to claim 5, wherein the light shielding unit is made of a black material.

7. The LCD panel according to claim 6, wherein the black material is a black photoresist.

8. A liquid crystal display (LCD) device, comprising a backlight module and an LCD panel, wherein the LCD panel comprises:
a first substrate, including an outer surface;
a first polarizer, disposed on the outer surface of the first substrate;
a second substrate, disposed opposite to the first substrate and including an outer surface;
a second polarizer, disposed on the outer surface of the second substrate, wherein the second polarizer includes an outer surface;
a liquid crystal (LC) layer, disposed between the first substrate and the second substrate; and
a light shielding unit, disposed on a periphery of the outer surface of the second substrate or disposed on a periphery of the outer surface of the second polarizer.

9. The LCD device according to claim 8, wherein when the light shielding unit is disposed on the periphery of the outer surface of the second substrate, the light shielding unit is located between the second substrate and the second polarizer.

10. The LCD device according to claim 9, wherein the light shielding unit is made of a black material.

11. The LCD device according to claim 10, wherein the black material is a black photoresist.

12. The LCD device according to claim 8, further comprising a covering layer, wherein the covering layer is disposed on the outer surface of the second polarizer; and when the light shielding unit is disposed on the periphery of the outer surface of the second polarizer, the light shielding unit is located between the second polarizer and the covering layer.

13. The LCD device according to claim 12, wherein the light shielding unit is made of a black material.

14. The LCD device according to claim 13, wherein the black material is a black photoresist.

15. A liquid crystal display (LCD) panel, comprising:
a first substrate, including an outer surface;
a first polarizer, disposed on the outer surface of the first substrate;
a second substrate, disposed opposite to the first substrate and including an outer surface;
a second polarizer, disposed on the outer surface of the second substrate, wherein the second polarizer includes an outer surface;
a liquid crystal (LC) layer, disposed between the first substrate and the second substrate; and
a light shielding unit, disposed on a periphery of the outer surface of the second substrate or disposed on a periphery of the outer surface of the second polarizer, wherein
the light shielding unit is made of black insulation ink and is arranged in a bezel area, so that a protective cover plate presents a black bezel;
when the light shielding unit is disposed on the periphery of the outer surface of the second substrate, the light shielding unit is located between the second substrate and the second polarizer;
when the light shielding unit is disposed on the periphery of the outer surface of the second polarizer, the light shielding unit is located between the second polarizer and the covering layer; and
the light shielding unit is equal in width or unequal in width, or portions of the light shielding unit are equal in width.
